(19) United States
(12) Patent Application Publication
(10) Pub. No.: US 2013/0326069 A1
(43) Pub. Date: Dec. 5, 2013

(54) Configuring Wireless Devices Over a Wireless Connection

(71) Applicants: Eric Chinhai Wang, San Jose, CA (US); Jesse Lloyd Lowe, San Jose, CA (US)

(72) Inventors: Eric Chinhai Wang, San Jose, CA (US); Jesse Lloyd Lowe, San Jose, CA (US)

(21) Appl. No.: 13/484,067

(22) Filed: May 30, 2012

(51) Int. Cl. H04W 76/02; G06F 15/16

(52) U.S. Cl. 709/227

(57) ABSTRACT

Approaches for a network attached device and method for establishing a wireless network are described. A client device connects to the wireless network in a session and sends configuration data relating to the wireless network over the wireless network. The configuration data is received and the wireless network is reconfigured. Without interrupting the session, the client device automatically attempts to contact the reconfigured wireless network.

### FIELD OF THE INVENTION

Embodiments of the invention relate to configuring a wireless device over a wireless connection.

### BACKGROUND OF THE INVENTION

The use of wireless networks has become commonplace in recent years, and the proliferation of wireless-enabled devices, such as cell phones, tablet PCs, laptops, PCs, and the like, shows no sign of slowing. Often, a device establishing a wireless local area network (WLAN), such as a wireless router or wireless access point, needs to be configured; for example, to set the network name (SSID) or change security settings for the WLAN. This configuration may need to be performed from another device connected via the WLAN, and changing the settings of the WLAN may result in this other device (among others) disconnecting its current session from the WLAN. Therefore, the status of the configuration process cannot be communicated between the devices, and a user may mistakenly attempt to repeat the configuration process or be otherwise confused as to how to proceed. This makes the configuration of wireless networks and devices over a wireless connection difficult.

Many different wireless devices, not only wireless routers and access points, may require configuration settings transmitted from another wireless device. Given the importance of wireless-enabled devices in today's society, it is desirable to allow for easier and efficient configuration of wireless devices utilizing a wireless connection.

### SUMMARY OF THE INVENTION

Embodiments are directed towards network attached devices and methods for establishing a wireless network wherein a client device connects to the wireless network in a single session and sends configuration data relating to the wireless network over the wireless network. The configuration data is received and the wireless network is reconfigured. Without interrupting the session, the client device automatically attempts to contact the reconfigured wireless network.

In an embodiment, a network attached device or digital storage device comprises or employs one or more processors, a wireless network component and one or more persistent storage devices such as a magnetic hard-disk drive or a solid state device. The network attached device establishes a wireless network and connects a client device to the network in a first session. The network attached device receives configuration instructions for the wireless network at the network attached device from the client device over the wireless network. Without interrupting the first session, the wireless network is configured according to the configuration instructions and the client device is connected to the reconfigured wireless network.

In an embodiment, a network attached device or digital storage device comprises or employs one or more processors, a wireless network component and one or more persistent storage devices such as a magnetic hard-disk drive or a solid state device. The network attached device establishes a wireless network having a first SSID. The client device connects to the wireless network in a first session and the network attached device sends data to the client device causing the client device to display a web page or similar element configured to receive configuration data comprising a second SSID. The network attached device receives the configuration data and changes the SSID of the wireless network to the second SSID without interrupting the first session. The configuration data is transmitted to the network attached device over the wireless network and the client device attempts to detect a wireless network comprising the second SSID and connect to the network attached device without interrupting the first session. Once the client device detects a connection to the wireless network with the second SSID, it displays a first status message. Without interrupting the first session, once the client device connects to the network attached device, it displays a second status message.

In an embodiment, a method is described wherein a network attached device establishes a wireless network and connects a client device to the network in a first session. The network attached device receives configuration instructions for the wireless network at the network attached device from the client device over the wireless network. Without interrupting the first session, the wireless network is configured according to the configuration instructions and the client device is connected to the reconfigured wireless network.

Embodiments discussed in the Summary of the Invention section are not meant to suggest, describe, or teach all the embodiments discussed herein. Thus, embodiments of the invention may contain additional or different features than those discussed in this section.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 is a block diagram of a network attached device according to an embodiment of the invention;

FIG. 2 is a flowchart of the steps performed in configuring a wireless device over a wireless connection according to an embodiment of the invention;

FIG. 3 is a an illustration of a interface element according to an embodiment of the invention;

FIG. 4 is a an illustration of a interface element according to an embodiment of the invention;

FIG. 5 is a an illustration of a interface element according to an embodiment of the invention;

FIG. 6 is a an illustration of a interface element according to an embodiment of the invention; and

FIG. 7 is a block diagram that illustrates a computer system upon which an embodiment of the invention may be implemented.

### DETAILED DESCRIPTION OF THE INVENTION

Approaches for configuring wireless devices over a wireless connection are presented herein. In the following description, for the purposes of explanation, numerous specific details are set forth in order to provide a thorough understanding of the embodiments of the invention described herein. It will be apparent, however, that the embodiments of the invention described herein may be practiced without these specific details. In other instances, well-known structures and devices are shown in block diagram form in order to avoid unnecessarily obscuring the embodiments of the invention described herein.

### Functional Overview

Example devices, methods and systems for a wireless configuration approach are discussed. In the following description, for purposes of explanation, numerous specific details are set forth in order to provide a thorough understanding of example embodiments. It will be evident, however, to one skilled in the art that the present subject matter may be practiced without these specific details. It will also be evident that the types of configuration details described herein are not limited to the examples provided and may include other scenarios not specifically discussed.

An example embodiment of the invention is directed towards an approach for configuring, over a wireless network connection, a wireless networking-capable device such as a network attached device, digital storage device, wireless router, or any type of wireless device and providing a user-friendly approach to communicating the status of the configuration process. An embodiment is directed to a network attached device having the capability to connect wirelessly to a number of client devices, for example by establishing a WLAN to which the client devices may connect. For purposes of this disclosure, “WLAN” may be construed to mean any type of wireless network. While reference is made to a “network attached device,” it should be understood that the example approaches described herein may utilize any type of device capable of network communication; for example, a device utilizing digital storage, such as a network-capable hard drive. The approaches described herein may also be utilized by, for example, printers, routers, wireless access points, cellular devices, tablets and computers.

In an embodiment, a network attached device (or “digital storage device”) establishes a WLAN to which client devices may connect. One of these client devices may initiate a configuration process on the network attached device, for example, to change the SSID of the WLAN. This configuration may be initiated in any number of ways; for example, by the client device joining the SSID of the WLAN established by the network attached device or typing a network address of the network attached device into a web browser on the client device. In response, the network attached device transmits a configuration web page to the client device via a web server component. The client device uses the configuration web page to display and receive configuration options. An illustrative configuration option which may be configured is the SSID of the WLAN established by the network attached device. Once the configuration options are input and confirmed, the configuration process is initiated at the network attached device. The configuration web page displays a message that the configuration process is underway. After a predetermined amount of time, the configuration web page checks whether the new SSID is being established (i.e., it “pings” the network for the new SSID) while suppressing any error messages that may be generated by the web browser due to a lack of network connectivity (because the SSID of the network to which the client device was connected has changed).

Once the new SSID is found, the configuration web page displays a message requesting the user to change the client device's wireless settings to join the new SSID being established by the network attached device, and begins pinging the network attached device. Once the ping is returned, then the configuration web page may display a message reflecting the successful completion of the setup process. This and alternate embodiments are discussed herein. Advantageously, these embodiments allow a streamlined approach to configuring a wireless device over a wireless connection.

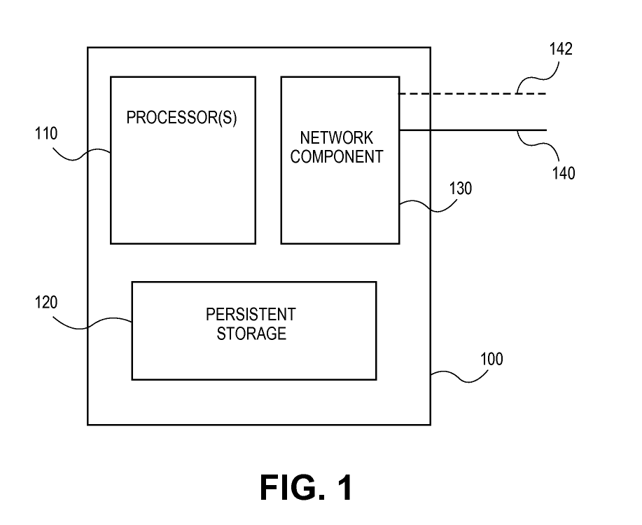

FIG. 1 is a block diagram of a network attached device 100 according to an embodiment. Device 100 may include one or more processors 110, a persistent storage 120, and a network component. A commercial, non-limiting example of device 100 is a device in the G-Connect family of products from Hitachi Global Storage Technologies of San Jose, Calif.

Persistent storage 120 broadly refers to any persistent storage medium for storing digital data. Persistent storage 120 may be implemented using a hard-disk or a solid-state device.

Network component 130 broadly refers to any component capable of enabling device 100 to communicate over a network. Network component 130 may enable device 100 to communicate over a physical network connection 140 and/or a wireless network connection 142, including establishing a WLAN to which other devices can connect. In an embodiment, network component 130 comprises a web server component to receive and respond to requests and to transmit data, such as web pages comprised of HTML, CSS, JavaScript or other technology known in the art. In an embodiment, network component 130 may also enable device 100 to act as a Wi-Fi hotspot for other wireless devices.

### Configuring a Wireless Device Over a Wireless Connection

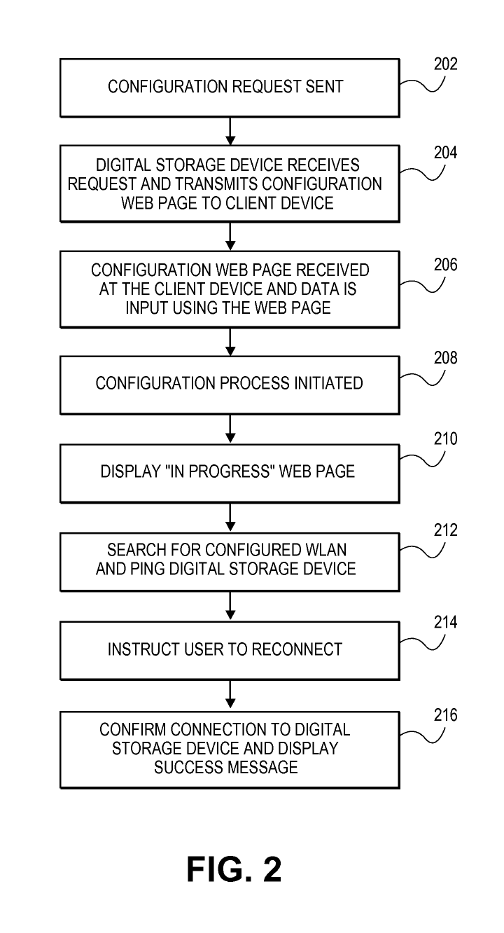

FIG. 2 is a flowchart of the steps performed in configuring a wireless device over a wireless connection according to an example approach. In step 202, a client device sends a request to configure a network attached device comprising a network component capable of establishing a WLAN. While this embodiment comprises a network attached device, any type of wireless-enabled device is envisioned. In various embodiments, the client device may be any type of wireless-enabled device, such as a cell phone, tablet PC, laptop, desktop PC, and the like. This configuration request may be initiated in any number of ways; for example, having the client device join a WLAN being established by the network attached device. Once the network attached device identifies that the client device has joined the WLAN, then the network attached device initiates the configuration process as discussed herein. Another way the configuration request may be sent from the client device to the network attached device is by connecting the client device to a network address associated with the network attached device, for example by typing a network address into a web browser executing on the client device. Other approaches of initiating the configuration process are envisioned. For purposes of the embodiment under discussion, the client device has joined the WLAN being established by the network attached device.

In step 204, once the request to initiate the configuration process has been sent from the client device, the network attached device receives the request and transmits data to the client device over the WLAN. This data may comprise web pages, image files, executable code or any other type of computing resource capable of executing instructions and displaying, receiving and transmitting information. While “configuration web page” will be used in the discussion of this embodiment to describe the data sent from the network attached device to the client device, it should be understood that any type of digital resource may be used. Further, while discussion of the present embodiment references a “configuration web page” and other “web pages,” it should be understood that these web pages may take the form of any type of code capable of being processed on a client device, and that any number of “web pages” or other code may be transmitted from the network attached device to the client device, either individually or combined. This “configuration web page” or other “web pages” may comprise HTML, CSS, JavaScript, Java, or any type of web technology known in the art. According to an embodiment, the network attached device may, in response to the configuration request, transmit an instruction to the client device to initiate the configuration process using resources (such as web pages and/or other resources) already stored on the client device.

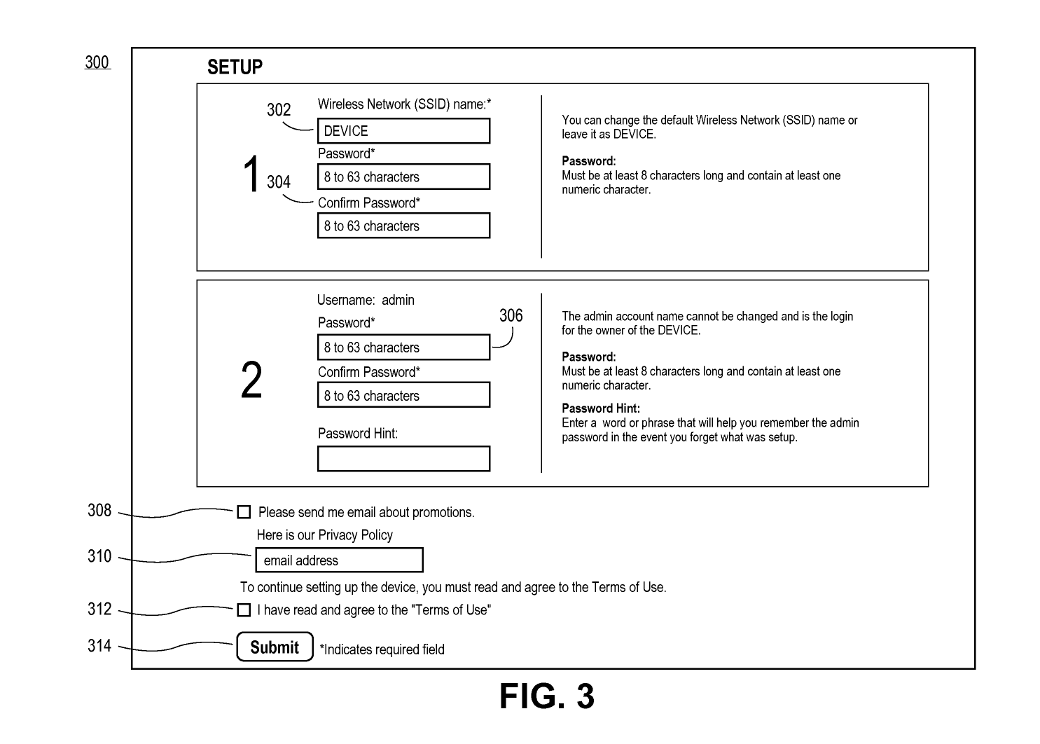

An example of a configuration web page is illustrated in FIG. 3. The configuration web page 300 may display information about the configuration of a WLAN being established by the network attached device; for example, the SSID of the WLAN 302, the security options of the WLAN 304 including passwords and encryption options and schemes. the availability of an administrator account and information associated with the account 306, an option to receive information 308 such as marketing information to an email address, the existence of a privacy policy and a link to the policy 310, a confirmation that the user has read and agrees to certain terms and conditions 312, and an interface element to submit the configuration settings and initiate the configuration process 314. In an embodiment, this configuration web page is viewed in a web browser executing on the client device; however, additional embodiments are envisioned wherein other approaches are used to display information on the client device.

Returning to FIG. 2, in step 206, the configuration web page is received and displayed by the client device (e.g., in a web browser), and a user enters information into the configuration web page related to configuring the WLAN. In the example embodiment of the present discussion, the user inputs a new SSID for the WLAN being established by the network attached device.

In step 208, the configuration information related to configuring the wireless device, in this case a network attached device, is transmitted over the WLAN from the client device to the network attached device, and the network attached device initiates the configuration process. In the present example, this includes changing the SSID of the WLAN being established by the network attached device. As will be discussed, as a result of the SSID changing, the client device loses connection to the WLAN.

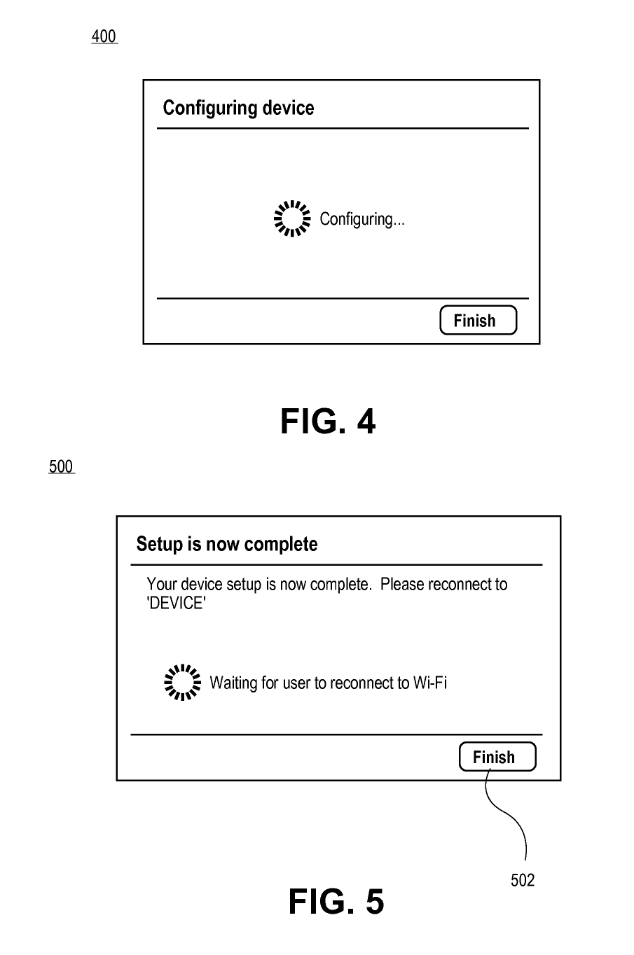

In step 210, the configuration web page changes to indicate that the configuration process has begun. An example of this web page 400 is illustrated in FIG. 4. As stated earlier, this “configuration web page” may be understood to mean a single set of resources transmitted to and stored on the client device, or multiple resources. This web page or group of web pages may further include additional resources such as image files and instructions in JavaScript or a similar language.

In step 212, the configuration web page on the client device begins to search for the re-configured WLAN; in this example, a WLAN identified by the new SSID. In addition (or as part of the same process), the configuration web page begins at regular intervals to check to see if the network attached device is reachable via the WLAN. This is commonly known as “pinging” a device, in this case, the network attached device. Because, as stated earlier, the client device is no longer connected to the WLAN, the configuration web page overrides any attempt by the client web browser to return a no web page found error (commonly referred to as a “404 error”), for example by overriding any attempt to “refresh” the configuration web page before the newly-configured WLAN is available. In an embodiment, this is accomplished with JavaScript code executed on the client as part of the configuration web page. This allows for a more graceful transition to the newly-configured WLAN, because users are not presented with an error message when the client device browser attempts to refresh a web page when there is no WLAN connection.

Once the newly-configured WLAN is found, control proceeds to step 214 where the configuration web page changes again to indicate that the network attached device setup has been accomplished, and directs the user to connect the client device to the newly-configured WLAN. An example of this web page is illustrated in FIG. 5. It should be noted that in this embodiment, the web page 500 has a “Finish” button 502 that is disabled (“grayed-out”) at this point in the configuration process. The configuration web page continues to ping the network attached device in the background while these steps are being performed. As part of the process of the user connecting the client device to the newly-configured WLAN, a password may be required, such as with reference to element 304 of FIG. 3.

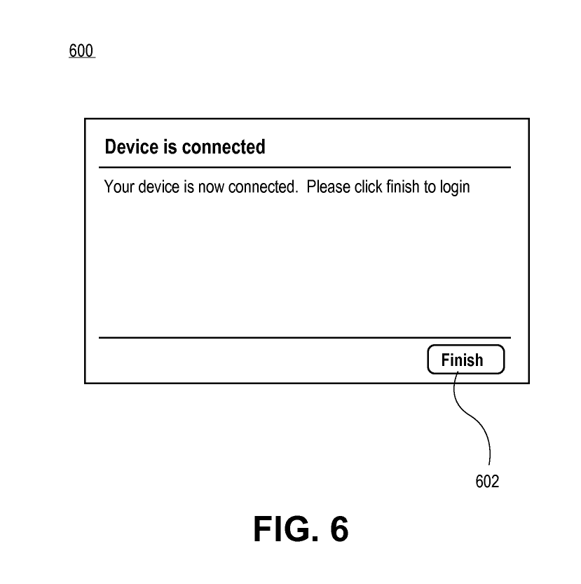

In step 216, once the user has reconnected the client device to the newly-configured WLAN, confirmation is made that the client device can connect to the network attached device via the wireless connection. In an embodiment, this is confirmed by the receipt of a success code by the client device, for example a “200” HTTP message. Once connection is established, then the configuration web page changes to indicate that the client device is now connected. An example of this web page is illustrated in FIG. 6. It should be noted that in this embodiment, the web page 600 has a “Finish” button 602 that may be selected by a user. It is no longer “grayed-out.” In an embodiment, after the user submits the setup form, a request is sent for the status of the server. This request is sent until the network attached device responds with a valid response code indicating it is connected. Once the valid response code is received, the client changes the status message to the user and enables finish button 602.

Once a user presses the “Finish” button 602 or takes some equivalent action according to an embodiment, then the configuration web page is dismissed. Additional embodiments are envisioned wherein additional steps are triggered as a result of receiving confirmation that the client device is connected to the WLAN. For example, upon receiving a “200” code, content could be downloaded and/or synchronized between devices using the WLAN. According to an embodiment, data may be synchronized between any devices connected to the network attached device via a network. This data may comprise files such as text documents, images and video, or configuration data for the devices. This synchronization process may be automatically initiated or manually, and the set of data transmitted may be predefined, such as “synchronize all data changed since the last synchronization,” or may be selected manually. This synchronization may take place without finishing the connection approach described herein. Once the client device is connected to the network attached device

In an example approach, a user pressing the “Finish” button results in the client device submitting a “HTTP POST” action to the server, after which the client device sends response requests to the server every 5 seconds. If the client (e.g., user's web browser) gets a valid response (e.g., “200” status code) it ends the process and redirects the user to the device login screen. However, if the SSID name has changed, the connection would typically be dropped when the resulting “404” status code is received (commonly known as a timeout error due to inactivity or non-responsiveness from the server). This timeout or non-responsiveness can be (but is not limited to) the result of a default action from the web browser. Once the user's web browser receives the timeout notification, it alerts the user that they must reconnect to the Wi-Fi (SSID name) in order to complete the setup process. According to an example, all pinging and error handling functions are done in a non-blocking manner through asynchronous calls.

By overriding any default “refresh” behavior of a web browser on the client device, the approach described herein allows for the user to perceive that a single session was maintained between the network attached device and the client device regardless of any changes. According to an example, a session remains active by disregarding a server failure status code and maintaining a HTTP POST request until the application detects the network attached device is connected and available.

By way of alternate embodiments, the techniques described herein may be applied to any wireless mobile device. For example, a mobile phone or tablet may use these approaches to connect to and configure a wireless network by way of a configuration web page or an application executing on the mobile phone or tablet.

While certain approaches described herein are directed to a configuration process for a network attached device, it should be understood that the configuration process as described may be utilized in other environments and with other devices. For example, the configuration process described herein may be used with devices using certain operating systems and/or software that does not transmit “web pages,” but does use server status codes (e.g., “200”) or an equivalent. Also, the configuration process described herein is not limited to the configuration of a Wi-Fi device; for example, it may be configured to be used by a web page (or web server) to check if a particular device is connected to a remote device and then perform an action.

Further, the configuration process described herein is not limited to the specific details of any examples described herein and may be modified to utilize different hardware and/or software in order to practice the techniques described herein.

### Hardware Mechanisms

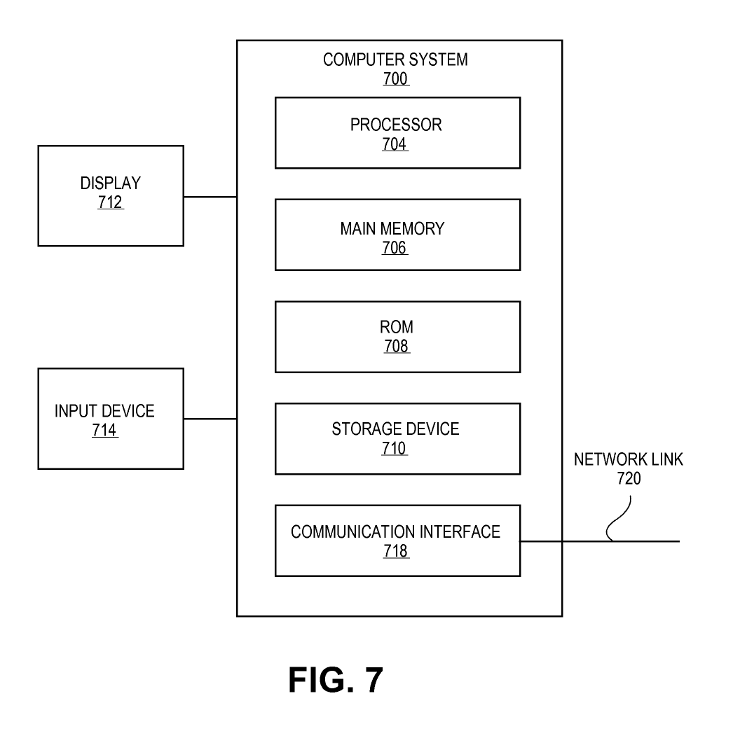

In an embodiment, device 100 of FIG. 1 may be implemented on, include, or correspond to a computer system. FIG. 7 is a block diagram that illustrates a computer system 700 upon which an embodiment may be implemented. In an embodiment, computer system 700 includes processor 704, main memory 706, ROM 708, storage device 710, and communication interface 718. Computer system 700 includes at least one processor 704 for processing information. Computer system 700 also includes a main memory 706, such as a random access memory (RAM) or other dynamic storage device, for storing information and instructions to be executed by processor 704. Main memory 706 also may be used for storing temporary variables or other intermediate information during execution of instructions to be executed by processor 704. Computer system 700 further includes a read only memory (ROM) 708 or other static storage device for storing static information and instructions for processor 704. A storage device 710, such as a magnetic disk or optical disk, is provided for storing information and instructions.

Computer system 700 may be coupled to a display 712, such as a cathode ray tube (CRT), a LCD monitor, and a television set, for displaying information to a user. An input device 714, including alphanumeric and other keys, is coupled to computer system 700 for communicating information and command selections to processor 704. Other non-limiting, illustrative examples of input device 714 include a mouse, a trackball, or cursor direction keys for communicating direction information and command selections to processor 704 and for controlling cursor movement on display 712. While only one input device 714 is depicted in FIG. 7, embodiments may include any number of input devices 714 coupled to computer system 700.

Embodiments are related to the use of computer system 700 for implementing the techniques described herein. According to one embodiment of the invention, those techniques are performed by computer system 700 in response to processor 704 executing one or more sequences of one or more instructions contained in main memory 706. Such instructions may be read into main memory 706 from another machine-readable medium, such as storage device 710. Execution of the sequences of instructions contained in main memory 706 causes processor 704 to perform the process steps described herein. In alternative embodiments, hard-wired circuitry may be used in place of or in combination with software instructions to implement embodiments of the invention. Thus, embodiments of the invention are not limited to any specific combination of hardware circuitry and software.

The term “machine-readable storage medium” as used herein refers to any tangible medium that participates in storing instructions which may be provided to processor 704 for execution. Such a medium may take many forms, including but not limited to, non-volatile media and volatile media. Non-volatile media includes, for example, optical or magnetic disks, such as storage device 710. Volatile media includes dynamic memory, such as main memory 706.

Non-limiting, illustrative examples of machine-readable media include, for example, a floppy disk, a flexible disk, hard disk, magnetic tape, or any other magnetic medium, a CD-ROM, any other optical medium, a RAM, a PROM, and EPROM, a FLASH-EPROM, any other memory chip or cartridge, or any other medium from which a computer can read.

Various forms of machine readable media may be involved in carrying one or more sequences of one or more instructions to processor 704 for execution. For example, the instructions may initially be carried on a magnetic disk of a remote computer. The remote computer can load the instructions into its dynamic memory and send the instructions over a network link 720 to computer system 700.

Communication interface 718 provides a two-way data communication coupling to a network link 720 that is connected to a local network. For example, communication interface 718 may be an integrated services digital network (ISDN) card or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through a local network to a host computer or to data equipment operated by an Internet Service Provider (ISP).

Computer system 700 can send messages and receive data, including program code, through the network(s), network link 720 and communication interface 718. For example, a server might transmit a requested code for an application program through the Internet, a local ISP, a local network, subsequently to communication interface 718. The received code may be executed by processor 704 as it is received, and/or stored in storage device 710, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A network attached device, comprising:
one or more processors;
a wireless network component;
one or more persistent storage mediums storing one or more sequences of instructions, which when executed by the one or more processors, cause:
establishing a wireless network from the network attached device;
connecting a client device to the wireless network, wherein the connection comprises a first session;
receiving configuration instructions for the wireless network at the network attached device from the client device over the wireless network; and
without interrupting the first session:
configuring the wireless network according to the configuration instructions, and
connecting the client device to the reconfigured wireless network.

2. The network attached device of claim 1, wherein the execution of the one or more sequences of instructions further causes:
transmitting instructions over the wireless network from the network attached device to the client device, wherein the instructions cause the client device to attempt to connect to the network attached device at regular intervals while the wireless network is being configured without interrupting the first session.

3. The network attached device of claim 1, further comprising a web server.

4. The network attached device of claim 2, wherein the instructions comprise at least one web page viewed in a web browser executing on the client device.

5. The network attached device of claim 4, wherein the web page comprises HTML and JavaScript.

6. The network attached device of claim 4, wherein the instructions further cause the web browser not to refresh the web page.

7. The network attached device of claim 4, wherein the instructions further cause the web browser to display a web page describing the status of the connection between the client device and the wireless network.

8. The network attached device of claim 2, wherein the instructions cause the client device to attempt to connect to the network attached device continuously while the wireless network is being configured.

9. The network attached device of claim 2, wherein the instructions further cause the client device to attempt to detect the reconfigured wireless network at regular intervals while the wireless network is being configured.

10. The network attached device of claim 1, wherein the configuration instructions comprise instructions to change the SSID of the wireless network, and configuring the network comprises changing the SSID of the wireless network.

11. The network attached device of claim 1, wherein the configuration instructions comprise instructions to change the security settings of the wireless network, and configuring the network comprises changing the security settings of the wireless network.

12. The network attached device of claim 1, further comprising:
after connecting the client device to the reconfigured wireless network, transmitting data to the client device over the reconfigured wireless network indicating that the client device has been successfully connected to the reconfigured wireless network.

13. The network attached device of claim 12, wherein the data comprises a 200 OK HTTP status code.

14. The network attached device of claim 1, further comprising:
after connecting the client device to the reconfigured wireless network, causing data to be synchronized between the client device and the network attached device.

15. A network attached device, comprising:
one or more processors;
a wireless network component;
one or more persistent storage mediums storing one or more sequences of instructions, which when executed by the one or more processors, causes:
establishing a wireless network from the network attached device, wherein the wireless network comprises a first SSID;
connecting a client device to the wireless network, wherein the connection comprises a session;
transmitting data to the client device over the wireless network, wherein the data when processed by the client device causes the client device to:
display a web page to receive configuration data, wherein the configuration data comprises a second SSID;
transmit the configuration data over the wireless network to the network attached device;
without interrupting the session, attempt to detect a wireless network comprising the second SSID and attempt to connect to the network attached device;
without interrupting the session, upon detecting a connection to a wireless network comprising the second SSID, display a first status message; and
without interrupting the session, upon connecting to the network attached device, display a second status message;
receiving the configuration data;
changing the SSID of the wireless network to the second SSID without interrupting the session; and
connecting the client device to the wireless network comprising the second SSID without interrupting the session.

16. The network attached device of claim 15, wherein the data transmitted to the client device over the wireless network comprises at least one web page.

17. The network attached device of claim 16, wherein the at least one web page comprises HTML and JavaScript.

18. The network attached device of claim 15, wherein the processing of the data by the client device comprises viewing the at least one web page in a web browser executing on the client device.

19. A method for configuring a wireless device, comprising:
establishing a wireless network from the network attached device;
connecting a client device to the wireless network, wherein the connection comprises a first session;
receiving configuration instructions for the wireless network at the network attached device from the client device over the wireless network; and
without interrupting the first session:
configuring the wireless network according to the configuration instructions, and
connecting the client device to the reconfigured wireless network.

20. The method of claim 19, further comprising:
transmitting instructions over the wireless network from the network attached device to the client device, wherein the instructions cause the client device to attempt to connect to the network attached device at regular intervals while the wireless network is being configured without interrupting the first session.
